(19) United States
(12) Patent Application Publication
(10) Pub. No.: US 2006/0010671 A1
(43) Pub. Date: Jan. 19, 2006

(54) Device for placing a stamped rivet in sheet metal

(75) Inventors: Roland Mair, Gotzis (AT); Erich Palm, Au (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS Intec Holding AG, Heerbrugg (CH)

(21) Appl. No.: 10/537,076

(22) PCT Filed: Dec. 16, 2003
(86) PCT No.: PCT/EP03/14303

§ 371 Date: Jun. 1, 2005

(30) Foreign Application Priority Data
Dec. 18, 2002 (DE) 10259369.8

(51) Int. Cl. B23P 11/00

(52) U.S. Cl. 29/243.53; 29/788; 29/798

(57) ABSTRACT

A device for installing a stamped rivet into sheet metal is provided having an upper socket in which a stamp can be displaced, a fixed lower socket which is located at a distance from the upper socket and which receives the shaft of the stamped rivet during the stamping-in process, and which also includes a clamping bushing which is elastically pre-tensioned and surrounds the lower socket and protrudes above the lower socket in a direction of the stamp and acts as a support for the sheet metal which is to be joined by or with the stamped rivet. The stamp, lower socket and clamping bushing are configured so that when the rivet is stamped in, a peripheral groove formed in the rivet shaft directly below the head is filled with metal sheet material which is stamped through by the rivet during the fixing process and is initially formed downwardly and then plastically deformed into the groove.

### BACKGROUND

The invention relates to a device for placing a stamped rivet in sheet metal.

The device according to the invention serves to place a stamped rivet for a connection to sheet metal without any pre-drilling. The stamped rivet is pressed through the sheet metal forming a punched hole. Through counter pressure, sheet metal material is pressed via plastic deformation into a circumferential groove, formed in the shaft of the stamped rivet.

A stamped rivet known from EP 1 013 945 B1 does not only represent a stamped rivet but simultaneously an embossed rivet as well. When such a stamped/embossed rivet has punched through two components to be connected to one another through formation of a punched hole, subsequently at the component located there, a groove is embossed around the end of the shaft opposite to the rivet head, causing material of the component located there to enter under plastic deformation into the circumferential groove formed in the shaft. For this purpose, a punching tool of the rivet placing device must be provided with an upwardly protruding flanged ring, which accepts the end of the shaft opposite to the head and thus embosses the groove around the end of the shaft into the material of the component located there. In this known stamped/embossed rivet, the circumferential groove is directly adjacent to the shaft end, so that the plastic deformation occurs in the material of the lower component only. The head of the stamped/embossed rivet has the form of a frustrum and, during the placing of the rivet, the rivet is pressed into the upper component to such an extent that the surface of the head of the installed rivet is flush with the surface of the upper component. Due to the embossing process necessary, such a stamped/embossed rivet requires a rivet placing device with a correspondingly complicated design.

A similar stamped/embossed rivet is known from U.S. Pat. No. 3,909,913. This stamped/embossed rivet varies from the above-mentioned one primarily in a slightly different shape of the head and the circumferential groove. However, U.S. Pat. No. 3,909,913 additionally shows the structure of the punching tool used for the punching process.

DE 297 07 669 U1 describes a punched rivet, which also is embodied as a punched/embossed rivet according to the above-mentioned definition. This publication shows an old construction of such a stamped/embossed rivet, in which the circumferential groove is arranged closer to the separating point of two components to be connected to one another than in the stamped/embossed rivet according to EP 1 013 945 B1, so that material of the lower part of the component is plastically deformed into the circumferential groove not only due to the punching process, but also material of the upper component is also deformed into the circumferential groove by the conically tapered head of the rivet. However, this stamped/embossed rivet seems to require a rivet placement device with an even more complicated design.

From U.S. Pat. No. 4,130,922 a stamped/embossed rivet is known, by which thin components or metal sheets can be connected to one another, however, for the placement of said rivet both the punching tool as well as the corresponding male counterpart must be provided such that a groove is not only punched around the end of the shaft in the component located here, but also a groove around the head of the rivet in the other component.

The respective prior art is also shown in U.S. Pat. No. 5,678,970, in which both the punching tool as well as its male counterpart are provided. When only the punching tool is provided, a rivet is used, in which the head is provided with a larger diameter than the end of the shaft. The head is countersunk flush with the upper component during the installation process, and a groove is only punched around the end of the shaft in the lower component.

From U.S. Pat. No. 4,978,270 a headless stamped/embossed rivet is known, which requires not only a punching tool and a corresponding male counterpart, but itself is additionally provided with several circumferential grooves. This allows it to connect three components arranged above one another.

Finally, DE 43 33 053 C2 shows a self-stamping fastening device, in which the rivet comprises a rivet head and a rivet shaft having a central recess, with its open facial surface not completely penetrating an accepting metal sheet.

For the connection to sheet metal, not only stamped rivets are known connecting two or more sheet metals to one another, but also embossed rivets, which are to be fastened to a sheet metal with the head of such embossed rivets, e.g., being provided in the form of a support pin. (U.S. Pat. No. 3,571,903). Here, the shaft can be provided such that during the installation process the sheet metal material surrounding the shaft is displaced upwards and is subsequently pushed back down by the support pin component of the embossed rivet, in order to be forced into the circumferential groove by way of plastic deformation and, thus, the embossed rivet contacts the metal sheet in a formfitting manner. Such embossed rivets cannot be placed into thin sheet metals, either. Although there is an embodiment in the known embossed rivet having a tapered section of the shaft in an area between the circumferential groove and the end of the shaft in the direction towards the end of the shaft, however, in this embodiment the rivet does not embody an embossed rivet but requires a pre-fabricated conical opening in the metal sheet, in which it is fastened by way of a special embodiment of the part of the shaft located above the circumferential groove via sheet metal material, which is plastically deformed into the circumferential groove.

For the placement of embossed rivets of the above-mentioned type it is also known (U.S. Pat. No. 1,275,576) additionally to insert a male embossing tool and to form the head in the groove punched by the male embossing tool.

### SUMMARY

The object of the invention is to provide a device of the above-mentioned type mentioned, which has a less complicated design; however, while also allowing setting of a stamped rivet such that a secure connection to thin sheet metal is made, either for connecting several thin metal sheets to one another or to connect the stamped rivet to one metal sheet.

Based on a device of the type mentioned at the outset, this object is attained by the device according to the invention that has an upper socket, which accepts a stamp in a shiftable manner, a fixed lower socket, which is distanced from the upper socket and accepts the shaft of the stamped rivet during the installation process, and a clamping bushing, elastically pre-stressed, surrounding the lower socket and protruding in reference thereto in the direction towards the stamp, as a support for the sheet metal to be connected to the stamped rivet or by the stamped rivet.

In the device according to the invention the punching tool and the male counterpart are of a simple construction, because merely an elastically pre-stressed clamping bushing is used instead of a stamping tool.

Advantageous embodiments of the stamped rivet according to the invention are provided in the sub claims.

When in an embodiment of the device according to the invention in which the stamp has a diameter equivalent to the diameter of the head of the stamped rivet, the individual stamped rivets can be processed easily by being pushed into the upper socket from below.

When in another embodiment of the device according to the invention in which the fixed lower socket has an outside diameter, which is greater than the diameter of the head of the stamped rivet, the amount of sheet metal material to be plastically deformed into the circumferential groove can be easily predetermined by the cooperation of the elastically pre-stressed clamping bushing.

When in another embodiment of the device according to the invention in which the outside diameter of the lower socket exceeds the diameter of the head of the stamped rivet by the difference between the diameter of the head and the greatest diameter of the shaft of the stamped rivet, the amount of material to be plastically deformed into the circumferential groove can be optimized even further.

When in another embodiment of the device according to the invention in which the interior diameter of the lower socket is identical or slightly larger than the diameter of the cylindrical shaft section of the stamped rivet, during the installation process the shaft penetrating the sheet metal into the lower socket can be accepted and subsequently the punched sheet metal on the shaft can be shifted back in the direction of the head of the stamped rivet.

When in another embodiment of the device according to the invention in which the stamped rivet is provided with a circular shoulder, which is elastically pre-stressed against a stop by way of a spring element arranged between a support and the circular shoulder, the punching tool is of a particularly simple structure.

When in another embodiment of the device according to the invention in which the spring element is a Belleville spring pack, the force, which is used to displace the sheet metal, after it has been punched by the stamped rivet, on the shaft of the stamped rivet back in the direction of its head, can be easily determined by the selection of the appropriate Belleville springs.

When in another embodiment of the device according to the invention in which a guiding member for stamped rivet—magazine strips is mounted to an exit end of the stamp of the upper socket, the magazined stamped rivets can be placed in a simple manner.

### BRIEF DESCRIPTION OF THE DRAWINGS

In the following, exemplary embodiments of the invention are explained in greater detail with reference to the drawings. In the drawings:

FIGS. 1a-1c show a first exemplary embodiment of a stamped rivet in a side view, a top view, and a perspective representation which can be installed according to the present invention,

FIG. 2a shows the stamped rivet according to FIGS. 1a-1c in the installed state, in which it connects metal sheets to one another and in which additionally a detail of the device according to the invention is shown,

FIG. 2b shows a second exemplary embodiment of the stamped rivet, which is installable with the device according to the invention, in the installed state, in which it connects metal sheets to one another,

FIG. 3 shows a first exemplary embodiment of the device according to the invention, and

FIG. 4 shows a second exemplary embodiment of the device according to the invention.

### DETAILED DESCRIPTION OF THE PREFERRED EMBODIMENTS

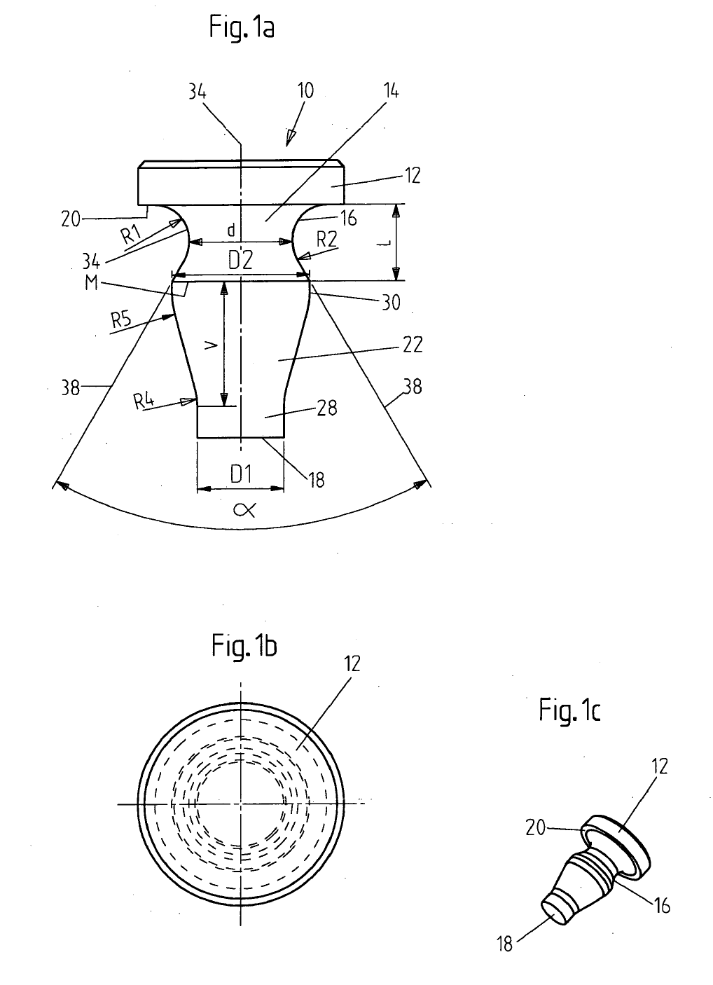

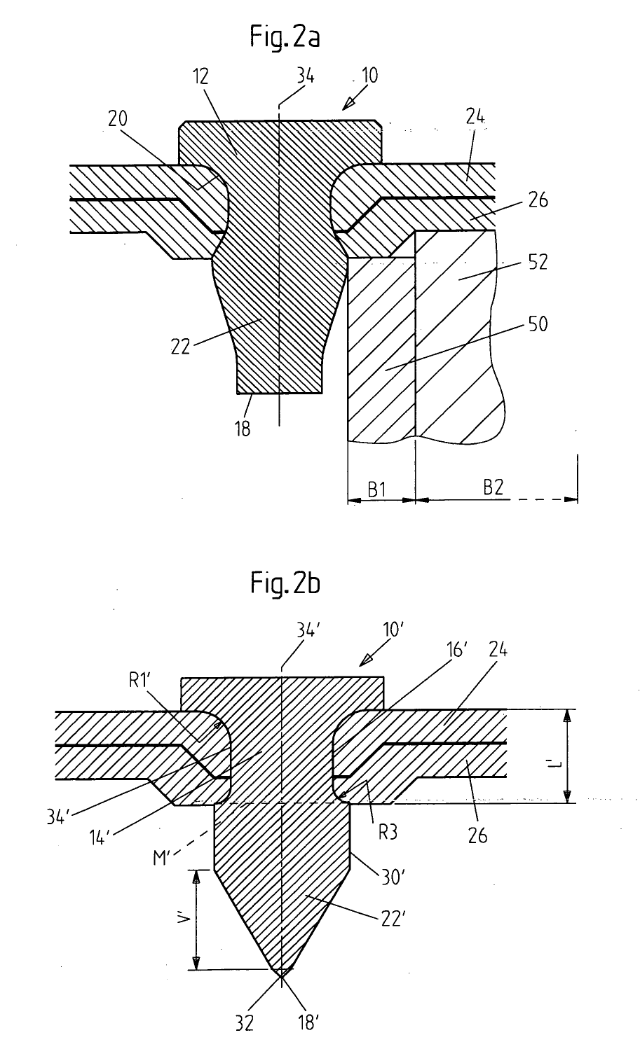

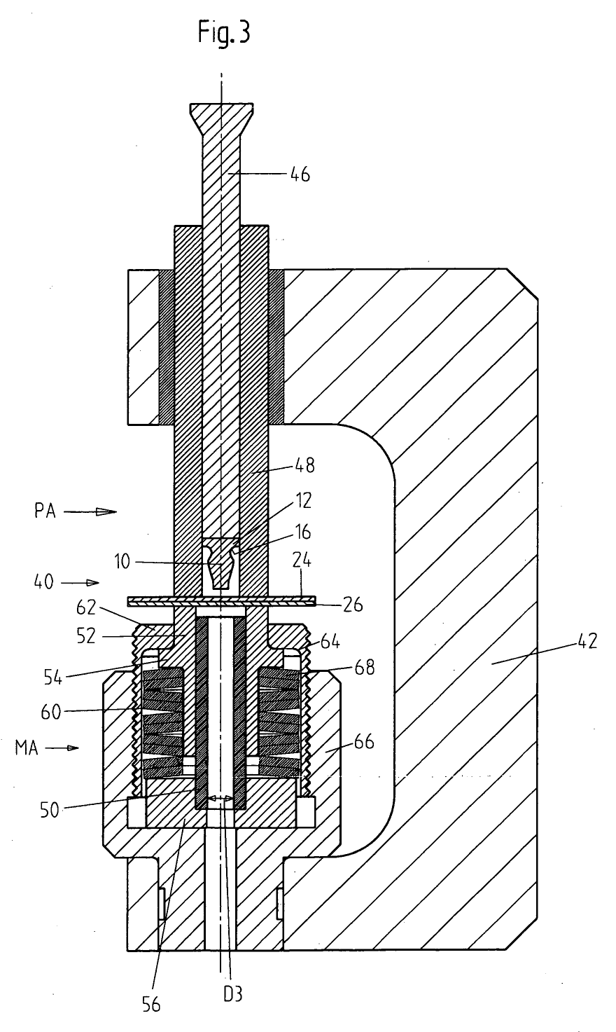

FIG. 1a is a top view of a first exemplary embodiment of the stamped rivet, indicated as 10 in its entirety, which can be installed by a device 40 or 40′ according to the invention, shown in FIGS. 3 and/or 4. In FIG. 2a the stamped rivet 10 is shown in the installed state. A second exemplary embodiment of the stamped rivet in the installed state is shown in FIG. 2b and indicated as 10′ in its entirety. FIGS. 2b, 3, and 4 will be explained in the following.

According to the representation shown in FIGS. 1a-1c, the stamped rivet 10 has a head 12, an adjacent shaft 14, a circumferential groove 16 in the shaft, and a shaft end 18 opposite to the head. The bottom of the head 12 is provided with a circular planar surface facing the shaft 14. The circumferential groove 16 is directly adjacent to the bottom of the head 12. A section 22 of the shaft 14 conically tapers in an area located between the circumferential groove 16 and the shaft end 18 in a direction of the shaft end 18. In the exemplary embodiment shown, the head 12 has a flat head, as easily discernible from FIGS. 1a and 1b, however, it could also be a round-head rivet or the like. It is essential for the invention that the circumferential groove 16 is directly adjacent to the planar surface 20, the purpose of which will become apparent in the following.

The stamped rivet 10, 10′ described here serves for the connection of thin metal sheets, i.e. either to connect two thin metal sheets 24, 26 to one another, as shown in FIGS. 2a and/or 2b, or to connect more than two thin metal sheets (not shown). However, the stamped rivet (10, 10′) can also be mounted to a thin metal sheet. In this case, the connection would look like FIGS. 2a and 2b, merely with the difference being that the separating line visible here between the two sheets 24, 26 would not be present. The individual thin metal sheet could certainly be thinner than the two thin metal sheets 24, 26 combined. In any case, the stamped rivet 10, 10′ shown in the two exemplary embodiments in FIGS. 1 and 2 has an axial length L (FIG. 1a) and L′ (FIG. 2b) of the circumferential groove 16, which is greater than the thickness of an individual metal sheet, to which the stamped rivet 10 or 10′ is to be connected, or the overall thickness of the metal sheets 24, 26 to be connected to one another by the stamped rivet 10, 10′. In the exemplary embodiment of the stamped rivet 10 shown in FIG. 1, the tapering section 22 of the shaft 14 extends to a cylindrical end section 28 having an outside diameter D1. In the stamped rivet 10′ shown in FIG. 2b, the tapering section 22′ extends to a pointed section 32 tapering in a more pointed manner than the tapering section 22′, ending in a shaft end 18′ formed as a tip. The tapering section 22, 22′ can be directly adjacent to the circumferential groove 16, 16′ (not shown). In the exemplary embodiments of the stamped rivet 10, 10′ shown and described here a cylindrical shaft section 30 and/or 30′ is directly adjacent to the circumferential groove 16 and/or 16′ and extends to the tapering section 22 and/or 22′ of the shaft 14.

In both exemplary embodiments of the stamped rivet 10, 10′, the circumferential groove 16, 16′ extends to a longitudinal center M and/or M′ of the stamped rivet. The tapering section 22, 22′ of the shaft 14, 14′ has an axial length V and/or V′, generally equivalent to the axial length L and/or L′ of the circumferential groove 16, 16′. In the first exemplary embodiment of the stamped rivet 10 the cylindrical end section 28 follows the tapering section with the length L. In the stamped rivet 10′, the pointed section 32 follows the axial length V′ of the tapering section. The overall length of the stamped rivet 10, 10′ is therefore considerably longer than, and preferably more than twice as long as an overall thickness of the sheet metal material, to which the connection with or by the stamped rivet 10, 10′ is to be made, with the aid of the device 40, 40′ according to the invention.

In the stamped rivet 10 as well as in the stamped rivet 10′, the circumferential groove 16 and/or 16′ blends via a first radius R1 with the planar surface 20, 20′ at the bottom of the head 12′. At the base in reference to a longitudinal axis 34, 34′, the circumferential groove 16, 16′ is parallel to the longitudinal axis 34, 34′ in the central area 36,36′ of the stamped rivet 10, 10′. In the stamped rivet 10, the circumferential groove 16 blends via a straight line 38 tilted in reference to the longitudinal axis 34 of the stamped rivet with the adjacent cylindrical shaft section 30, being the thickest part of the shaft 14, 14′ and having a diameter D2. The base of the circumferential groove 16 of the stamped rivet 10 blends via a second radius R2 with the straight line 38. In the stamped rivet 10′ the circumferential groove 16′ blends via a third radius R3 (FIG. 2b) with the adjacent cylindrical shaft section 30′, which also has the greatest shaft diameter D2. In the stamped rivet 10 the tapering section 22 blends via the fourth radius R4 with the cylindrical end section 28. Further, in the stamped rivet 10 the cylindrical shaft section 30 blends via the fifth radius R5 with the tapering section 22. The two straight lines 38, shown diametrically opposite to one another in FIG. 1a, form an angle α having 60°. The shaft end 18 is provided with sharp edges in the stamped rivet 10. Finally, in the stamped rivet 10 the diameter of the cylindrical end section 28 of the shaft 14 is equivalent to the smallest or slightly smaller than the smallest diameter d of the shaft 14 in the area of the circumferential groove 16.

In the two exemplary embodiments, the stamped rivet 10, 10′ comprises a material, which is harder than the sheet metal material, to which the stamped rivet is to create a connection. In both cases, the stamped rivet 10, 10′ is not deformed during the placing process. Only the sheet metal material to which a connection is to be made is deformed. During the production of the connection, the sheet metal material is plastically deformed into the circumferential groove 16, 16′. This results in a form-fitting connection of the stamped rivet 10, 10′ and the material of the sheet metals 24, 26, which is enclosed in the circumferential groove 16, 16′ between the planar surface 20, 20′ and a shoulder formed by the straight line 38 and/or by the radius R3.

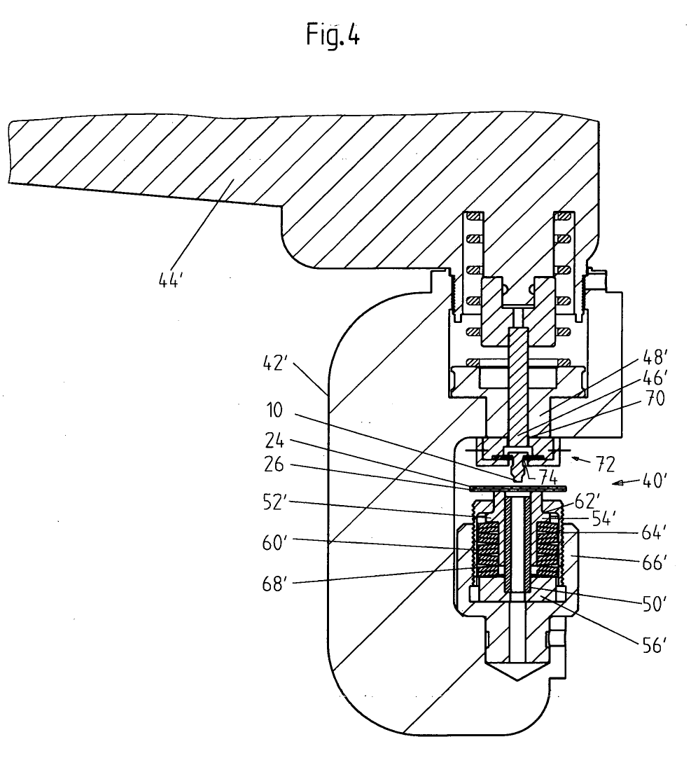

In FIG. 3, a first exemplary embodiment of a device for placing the stamped rivet 10 is shown, and is indicated as 40 in its entirety. The device 40 comprises a male stamping tool, indicated as PA in its entirety, and a bottom die, indicated MA in its entirety, between which the two metal sheets 24, 26 are clamped, shown in the representation of FIG. 3 to be connected to one another by the stamped rivet 10. The male stamping tool and the bottom die are connected to one another by a U-shaped yoke 42. It is discernible from FIG. 4 that in the second embodiment of the device for placing the stamped rivet 10, named 40′ in its entirety, that the yoke 42′ can be mounted to an electrically, hydraulically, or pneumatically driven tool 44′, which drives the stamp 46′ during the installation process. The drive of the stamp 46 is not shown in FIG. 3. In FIG. 3, the drive may be provided similar to the one shown in FIG. 4 or may occur manually, for example via a hammer.

In the device 40 according to FIG. 3, the male stamping tool PA is provided with an upper socket 48, which accepts the stamp 46 and the stamped rivet 10 in a shiftable manner, and which itself is held in the yoke 42 either fixed or displaceable. The bottom die MA is provided with a fixed lower socket 50, which is distanced from the upper socket 48, and which accepts the shaft 14 of the stamped rivet 10 during the stamping process. The lower socket 50 is surrounded by a slightly elastically, pre-tensioned clamping bushing 52, which protrudes from the lower socket 50 in a direction towards the stamp 46, and which serves as a support for the metal sheets 24, 26 that are to be connected to one another by the stamped rivet 10.

The stamp 46 of the device 40 has a diameter equivalent to the diameter of the head 12 of the stamped rivet 10. The fixed lower socket 50 has an outside diameter larger than the diameter of the head 12 of the stamped rivet 10. The lower socket 50 has an interior diameter D3. The interior diameter D3 is equivalent to the diameter D2 of the cylindrical shaft section 30 or slightly larger than the diameter D2. The outside diameter of the lower socket 50 is larger than the diameter of the head 12 of the stamped rivet 10 by the difference between the diameter of the head 12 and the largest diameter D2 of the shaft 14 of the stamped rivet 10, i.e. the diameter D2 of the cylindrical shaft section 30. The detail of the device 40, additionally represented in FIG. 2a, shows that the above-mentioned diameters are dimensioned such that sufficient space is available for the plastic deformation of the metal sheets 24, 26 in the area of the circumferential groove 16.

According to FIGS. 3 and 4, the clamping bushing 52, 52′ is provided with a circular shoulder 54, 54′, which is elastically pre-tensioned against a stop 62, 62′ by a spring member 60, 60′, arranged between a counter support 56, 56′, at which the lower socket 50, 50′ is mounted, the stop being formed by a shoulder of an interior threaded socket 64, 64′, into which an exterior threaded socket 66, 66′ of the bottom die MA is screwed. In the exemplary embodiment shown, the spring member 60, 60′ is formed by several Belleville springs 68, 68′ stacked on top of one another.

In addition to another type of drive, the device 40′ according to FIG. 4 varies from the device 40 according to FIG. 3 generally in that a guidance member for a stamped rivet—magazine strip 74 is mounted to a stamp exit end 70 of the upper socket 48′. The magazine strip comprises several stamped rivets 10 spaced apart from one another, which can be moved and placed one after the other by the stamp 46′.

The method for placing the stamped rivet 10 using the device 40, in which the stamped rivet is forced without any pre-drilling through the metal sheets 24, 26, forming a punched hole, and subsequently forcing sheet metal material into the circumferential groove 16, through being plastically deformed, is performed as follows. First, the stamped rivet 10 is forced downward with the help of the stamp 46, until it contacts the metal sheet 24. Subsequently the metal sheets 24, 26 and the clamping sleeve 52 are displaced downward by way of the stamp 46 and the stamped rivet 10, against the force of the Belleville springs 68, until the metal sheet 26 contacts the surface of the lower socket 50. From there on, the stamp 46 continues to move the stamped rivet 10 only and the stamping of the punched hole occurs by the cylindrical end section 28 of the stamped rivet 10. During the formation of the punched hole, the sheet metal material in a first circular area surrounding the punched hole is taken along in the stamping direction. In this manner, the edge sections of the punched hole are deformed downward. As soon as the metal sheets 24, 26 have been stamped, tensions release, reactivating the forces of the cup springs 68. They again displace the clamping sleeve 52 and the sheet metals 24, 26 upward to the extent the forces of the cup springs 68 are capable to shift the sheet metals 24, 26 upwards over the tapering section 22 of the stamped rivet 10 widening towards the top. Assuming sufficient force of the cup springs 68, the limit would be reached when the metal sheet 24 contacts the bottom of the upper socket 48. The metal sheets 24, 26 have thus been lifted off the lower socket 50, so that the metal sheets 24, 26 and the upper side of the lower socket 50 are separated. During this process, the stamp 46 has been moved forward continuously. Due to the sudden release of the force of the cup springs 68 the sheet metals 24, 26 have been shifted relatively far upwards on the stamped rivet 10 in the punched hole. Due to the continuous pressure acting onto the stamped rivet 10 by the stamp 46, the stamped rivet is finally forced farther downward through the punched hole until the planar surface 20 of the head 12 contacts the upper side of the metal sheet 24. From this point on, the stamped rivet 10 and the metal sheets 24 26 are displaced together downward until the metal sheet 26 contacts the upper side of the lower socket 50. Now the edge regions of the punched hole, deformed downwards, are plastically deformed into the circumferential grooves 16 in a first circular area B1 (FIG. 2a), by way of the stamp 46 on the lower socket 50 serving as a fixed counter support. FIG. 2a shows the final state of this deformation. During this deformation, a second circular area B2, surrounding the lower socket 50, is elastically supported by the clamping bushing 52. The sheet metal material is compressed during the deformation in the first circular area B1 to the length L of the circumferential groove 16. The metal sheets 24, 26 to be connected to one another or the thin metal sheet to be connected to the stamped rivet 10 preferably have a total thickness smaller than the length L of the circumferential groove 16. However, the overall thickness could also be greater than the length L of the circumferential groove 16. Due to the placement method according to the invention, the sheet metal material in the preferred exemplary embodiment shown experiences a thickening in the area of the circumferential groove 16 over the length L.

The installation process using the device 40′ according to FIG. 4 generally is carried out in the same manner as the device 40 shown in FIGS. 3 and 4 such that during the installation process, the metal sheets 24, 26 are not required to be clamped between the bottom die MA and the male counterpart PA. Both in the device 40 according to FIG. 3 as well as in the device 40′ according to FIG. 4, the stamp 46, 46′ moves the stamped rivet 10, 10′ downward during the placement process, with said stamped rivet forcing the clamping bushing 52, 52′ downward against the force of the spring member 60, 60′ while punching through the sheet metals 24, 26 until the metal sheet 26 contacts the surface of the lower socket 50, 50′ and with the sheet metal material, during the formation of the punched hole, being taken along in the stamping direction in a first circular area surrounding the punched hole. At this moment, the counterforce of the spring member 60, 60′ begins to exceed the force acting from above so that the clamping bushing 52, 52′ is abruptly forced upward in order to deform the sheet metal material in the first circular area B1 upward and into the circumferential groove 16, 16′. The stamping process and the deformation of the sheet metal material occur in the above-described manner.

1. A device for placing a stamped rivet into sheet metal, comprsing an upper socket (48, 48′), which accepts at least one stamp (46, 46′) in a shiftable manner, a fixed lower socket (50,50′), which is spaced apart from the upper socket (48, 48′) and accepts during an installation process a shaft (14, 14′) of the stamped rivet (10, 10′), and an elastically pre-stressed clamping bushing (52, 52′) surrounding the lower socket (50, 50′) and protruding therefrom in a direction of the stamp (46,46′), which provides a support for the sheet metal (24, 26) to be connected with or by the stamped rivet (10, 10′).

2. A device according to claim 1, wherein the stamp (46, 46′) has a diameter, which is equivalent to a diameter of a head (12, 12′) of the stamped rivet (10, 10′).

3. A device according to claim 1, wherein the fixed lower socket (50, 50′) has an outside diameter greater than a diameter of the head (12, 12′) of the stamped rivet (12, 12′).

4. A device according to claim 3, wherein the outside diameter of the lower socket (50, 50′) is greater than the diameter of the head (12, 12′) of the stamped rivet (10, 10′) by a difference between the diameter of the head (12, 12′) and a greatest diameter (D2) of the shaft (14, 14′) of the stamped rivet (10, 10′).

5. A device according to claim 4, wherein an interior diameter (D3) of the lower socket (50, 50′) is about the same size or slightly larger than the diameter (D2) of a cylindrical shaft section (30, 30′) of the stamped rivet (10, 10′).

6. A device according to claim 1, wherein the clamping bushing (52, 52′) is provided with a circular shoulder (54, 54′), which is elastically pre-stressed against a stop (62, 62′) by a spring element (50, 50′) arranged between a support (56, 56′) and the circular shoulder (54, 54′).

7. A device according to claim 6, wherein the spring element (60, 60′) is a Belleville spring packet.

8. A device according to claim 1, wherein a guidance member (72) for a stamped rivet—magazine strip (74) is mounted to a stamp exit end (70) of the upper socket (48′).
